(19) United States
(12) Patent Application Publication
(10) Pub. No.: US 2026/0166480 A1
(43) Pub. Date: Jun. 18, 2026

(54) INERTING SYSTEM

(71) Applicant: Airbus Operations Limited, FILTON (GB)

(72) Inventor: Henry EDWARDS, FILTON (GB)

(21) Appl. No.: 19/388,318

(22) Filed: Nov. 13, 2025

(30) Foreign Application Priority Data
Nov. 28, 2024 (GB) 2417514.3

(51) Int. Cl. B01D 53/24; B64D 13/06; B64D 37/32

(52) U.S. Cl. CPC B01D 53/24; B64D 13/06; B64D 37/32; B01D 2256/10; B01D 2256/12; B64D 2013/0666

(57) ABSTRACT

An inerting system, for instance an aircraft enclosure inerting system, is configured to separate an inlet air flow into nitrogen enriched air (NEA) and oxygen enriched air (OEA). The inerting system has a vortex tube with a vortex chamber in which the inlet air flow is separated into the NEA and the OEA. The inlet air flow enters the vortex chamber through an inlet passage which intersects the vortex chamber at a chamber inlet aperture. A warming device of the inerting system warms the inlet passage or the inlet air flow before the inlet air flow gets to the chamber inlet aperture.

### CROSS-REFERENCES TO RELATED APPLICATIONS

This application claims the benefit of United Kingdom Patent Application Number 2417514.3 filed on Nov. 28, 2024, the entire disclosures of which are incorporated herein by way of reference.

### FIELD OF THE INVENTION

The present disclosure relates to the field of vortex tubes for aircraft enclosure inerting systems. It relates particularly, but not exclusively, to vortex tubes for inerting systems which can be used to fill the ullage of an aircraft fuel tank with nitrogen enriched air as a fire safety precaution.

### BACKGROUND OF THE INVENTION

Owing to airworthiness requirements, most commercial aircraft require the use of fuel tank inerting systems among a suite of other measures to prevent aircraft fuel tank fires or explosions. The primary purpose of such inerting systems (also referred to as inert gas generation systems) is to reduce the oxygen (O₂) concentration within the aircraft fuel tank ullage, and hence the ullage flammability, thereby preventing the ability of the ullage to combust. State of the art systems comprise the use of one or more Air Separation Modules (ASMs) to separate bleed air into nitrogen enriched air (NEA), sometimes called oxygen depleted air, and oxygen enriched air (OEA). The OEA is exhausted overboard from the aircraft while the NEA is fed in a controlled manner at predetermined rates into the ullage above the fuel in the aircraft's fuel tank or tanks such that the O₂ concentration of the ullage is kept below an upper limit (for instance 12%) during most operating conditions of the aircraft.

In conventional systems bleed air, which is high temperature and pressure air bled from an engine or from a separate compressor fed by a ram air channel, is filtered and cooled before being inputted into the ASM(s). Cooling and filtering of the bleed air is important because the ASM contains a membrane, often in the form of a set of hollow fibers, over which the input air passes. The membrane can be clogged if the input air contains contaminants like dust, and degrades too rapidly if subjected to input air above a certain temperature. The membrane of the/each ASM is permeable to oxygen but not to nitrogen, so as the air passes over the membrane much of the oxygen it contains passes through the membrane while the nitrogen continues along it. This separates the air into the NEA and OEA. The NEA can then be regulated into the ullage, while the OEA can be discarded as mentioned.

An alternative way of producing NEA is through use of a vortex tube. A vortex tube has a vortex chamber into which air is formed into vortex. As the air rotates inside the chamber it produces a hotter stream around the outside and a colder stream towards the middle. Vortex tubes are generally used to provide cooling rather than air separation. However, oxygen, being denser than nitrogen, tends to be thrown out into the outer stream, leaving the inner stream in a nitrogen enriched state. Thus, the cold stream is NEA and the hot stream is OEA.

One problem with vortex tubes is that their inlet passages, through which air enters the vortex chamber, can become cooled over time, for instance due to the cooling effect of the expansion of air within them and/or due to the cold NEA stream passing close by. If the inlet passages are cooled below freezing point, moisture in the air can freeze upon contact with them, building up a layer of ice. The layer of ice can obstruct the inlet passages, either restricting the amount of air which can pass through them (which has a knock-on effect on vortex speed and throughput, and thus on separation performance) or blocking them altogether.

The conventional approach to deal with this problem is to use air drying equipment upstream of the vortex tube, thereby preventing moisture from reaching the potentially-freezing inlet passages. However, such equipment adds cost. They also add to the weight and bulk of the equipment, which in fields such as aeronautics is at a particular premium.

The present invention seeks to mitigate one or more of the above-mentioned problems. Instead or as well, the present invention seeks to provide an improved or alternative inerting system, aircraft, or method of supplying NEA to an enclosure.

### SUMMARY OF THE INVENTION

According to a first aspect of the present invention there is provided an inerting system configured to separate an inlet air flow into nitrogen enriched air (NEA) and oxygen enriched air (OEA), the inerting system having a vortex tube comprising:
a vortex chamber configured for centrifugal separation of the inlet air flow into the NEA and the OEA; and
a swirl generator having an inlet passage through which the inlet air flow can enter the vortex chamber, the inlet passage and vortex chamber intersecting at a chamber inlet aperture,
wherein the inerting system further comprises a warming device configured to warm at least part of the inlet passage, or at least part of the inlet air flow upstream of the chamber inlet aperture.

For the avoidance of doubt, the warming device may be configured to warm at least part of the inlet passage, which may have the effect of warming at least part of the inlet air flow. Equally, the warming device may be configured to warm at least part of the inlet air flow, which may have the effect of warming at least part of the inlet passage. Thus, the warming device may be configured to warm at least part of the inlet passage and at least part of the inlet air flow upstream of the chamber inlet aperture.

Warming at least part of the inlet passage or inlet air flow may make it less likely for moisture in the inlet air flow to freeze on the inlet passage and build up to form an obstruction, and/or may melt accumulated ice so as to clear it from the inlet passage. Also, generally speaking the warmer the inlet air flow is (whether warmed by the warming device or by the inlet passage), the warmer the NEA is and thus the less cooling effect it has on the vortex tube so the less likely it is for the inlet passage to reach freezing point. With the vortex chamber being more resistant to obstruction from ice, it may be more reliable and/or in need of less (or less frequent) maintenance. Further, being more resistant to obstruction from ice may enable the inerting system to utilize air drying equipment which is smaller, lighter and/or cheaper, or may even not require air drying equipment at all.

Instead or as well, dealing with ice accumulation by heating the inlet air or inlet passage may allow the inerting system to continue to operate while being cleared of ice, in contrast to other ways of clearing ice (such as shutting down the vortex tube until the ice melts, or passing de-icing liquid down the vortex tube). This, in turn, may mean that the supply of NEA can continue uninterrupted.

Warming at least part of the inlet passage may mean less power is required to clear ice and/or prevent it forming in the inlet passage, since it may be more economical to warm only the inlet passage than continually warming part of an air flow. In contrast, warming at least part of the inlet air flow upstream of the inlet passage may take more power as some may be wasted heating parts of the inlet air flow which do not ultimately contact the inlet passage as it flows through it. Having said this, warming at least part of the inlet air flow may allow the vortex tube (and thus the inerting system as a whole) to be advantageously simple, since inlet passages of vortex tubes are often small and inaccessible components which do not lend themselves to being heated.

Where the warming device is configured to warm at least part of the inlet passage, it may be configured to warm the at least part of the inlet passage directly, or indirectly via one or more intermediate components.

The swirl generator may be annular in shape, for instance being positioned circumferentially around (for example concentrically around) the vortex chamber. In such a swirl generator the inlet passage may be positioned tangentially to the vortex chamber.

Where it is not positioned circumferentially around the vortex chamber, the swirl generator (whether annular or otherwise) may be positioned at an axial end of the vortex chamber. In such a swirl generator the inlet passage may follow a helical path into the vortex chamber.

The warming device may be configured to warm substantially all of the inlet air flow or substantially all of the inlet passage.

This may increase the extent to which one or more of the advantages discussed above are provided.

The inerting system may further comprise one or more additional vortex tubes. The vortex tube and the additional vortex tube(s) may be connected in series (with the NEA produced by the most upstream vortex tube being further refined by the vortex tube(s) downstream of it) and/or in parallel (with each vortex tube receiving a portion of the inlet air flow and producing a portion of the NEA and OEA). Where the inerting system comprises one or more additional vortex tubes connected in series with the vortex tube, the vortex tube may be positioned upstream of the additional vortex tube(s), which may allow the additional vortex tube(s) to benefit from the warming provided at or upstream of the vortex tube.

The warming device may be provided in or on the vortex tube.

This may make the inerting system more compact. Instead or as well, by providing the heating at the vortex tube itself there may be less time for heat applied (either to the vortex tube for conduction to the inlet passage or to the inlet air flow) to dissipate before reaching the inlet passage.

The warming device may be embedded in the vortex tube, for instance in a component of the vortex tube such as an outer wall or inner flow-directing component. As an alternative, the warming device may be attached to a surface of the vortex tube such as an outer surface thereof.

Optionally:
the vortex tube comprises an inlet duct in communication with a plenum chamber, the inlet passage of the swirl generator providing a flow path from the plenum chamber into the vortex chamber; and
the warming device is provided at a wall defining the plenum chamber.

The warming device may therefore warm the inlet air flow as it enters the plenum chamber and/or while it is inside the plenum chamber, and/or heat may be conducted to the inlet passage from that wall along a relatively short path, which may reduce the opportunity for heat to dissipate before the warmed air reaches the inlet passage.

The warming device may be provided in and/or on the wall.

The plenum chamber may be annular in shape, for instance being positioned circumferentially around the vortex chamber. In such an embodiment the swirl generator may be annular in shape and positioned between the plenum chamber and the vortex chamber. Indeed, the swirl generator may form a wall of both the plenum chamber and the vortex chamber.

The warming device may extend circumferentially around the vortex chamber.

This may make the warming action of the warming device more even about the circumference of the vortex chamber, which reduce the risk of “cold spots” remaining, at which ice may accumulate or may not be detached.

The warming device may extend continuously around the vortex chamber. As an alternative, the warming device may comprise an array of discrete units which are distributed circumferentially around the vortex chamber.

It is to be understood that a warming device may be considered to extend circumferentially around the vortex chamber even if it does not quite extend around the full 360 degrees. For instance, the warming device may extend circumferentially around the vortex chamber through an angle of at least 270 degrees or at least 315 degrees.

Reference to the warming device extending circumferentially around the vortex chamber is not intended to mean that the warming device must necessarily be provided at a wall of the vortex chamber. A warming device may extend circumferentially around the vortex chamber while being spaced radially apart therefrom.

The warming device may be provided at the swirl generator.

This may position the warming device beneficially close to the inlet passage, therefore there may be less opportunity to for heat applied to the inlet air flow to dissipate before reaching the inlet passage. Instead or as well, the warming device being provided at the swirl generator may allow heat to be conducted to the inlet passage directly with less opportunity for it to dissipate.

The warming device may be provided in and/or on the swirl generator.

Optionally:
the swirl generator has a plurality of inlet passages through which the inlet air flow can enter the vortex chamber, each inlet passage intersecting the vortex chamber at a respective chamber inlet aperture; and
the warming device extends in or on the swirl generator between adjacent inlet passages.

By extending between adjacent inlet passages, the same warming device (or the same part of the warming device) may heat parts of the inlet air flow which are bound for two different inlet passages, or directly heat two inlet passages.

The swirl generator may comprise an annular array of the inlet passages, and the heating device may extend in or on the swirl generator between each adjacent pair of inlet passages around the array.

The warming device may extend in or on the swirl generator equidistantly between adjacent inlet passages.

The, or each, inlet passage may define a longitudinal axis, and the warming device may extend circumferentially around the, or each, inlet passage.

This may make the warming action of the warming device beneficially even around the, or each, inlet passage, thereby reducing the risk of an inlet passage having a “cold spot” about its circumference.

The warming device may extend continuously around the, or each, inlet passage. As an alternative, the warming device may comprise an array of discrete units which are distributed circumferentially around the, or each, inlet passage.

It is to be understood that a warming device may be considered to extend circumferentially around an inlet passage even if it does not quite extend around the full 360 degrees. For instance the warming device may extend circumferentially around an inlet passage through an angle of at least 270 degrees or at least 315 degrees.

Reference to the, or each, inlet passage defining a longitudinal axis is not intended to mean that the inlet passage must be straight.

The warming device may be positioned upstream of the inlet passage.

This may be beneficial in that more space may be available upstream of the inlet passage. This may allow the warming device to be configured for more thorough and/or more efficient warming, for instance being larger and/or having a larger surface area from which heat can pass, and/or may allow the vortex tube to have a simpler construction.

The warming device may be configured to warm at least part of the inlet air flow and may be positioned upstream of the vortex tube.

This may allow the inerting system to use a vortex tube of a simpler configuration, for instance one of conventional design which may be cheaper to purchase or manufacture, since such a vortex tube would not need to be configured to work with the warming device positioned in/on it. Instead or as well, it may allow the warming device and the vortex tube to be positioned at respective locations that are more suited to their function, for instance the warming device may be positioned near to a power source to avoid the need for long power cables while the vortex tube may be positioned nearer to the source of the inlet air flow, nearer to an enclosure which receives the NEA and/or nearer to an exhaust port for expelling OEA.

The warming device may be configured to raise the temperature of the at least part of the inlet passage or at least part of the inlet air flow by at least 20 degrees Celsius, for instance at least 30 degrees, at least 40 degrees, at least 50 degrees or at least 60 degrees.

This may improve the ability of the warming device to heat the inlet air flow or inlet passage sufficiently for ice to be melted or prevented from forming.

Raising the temperature of the substantially all the inlet air flow by at least 50 degrees Celsius may be of particular benefit since vortex tubes of conventional design typically produce NEA that is around 50 degrees colder than the inlet air flow. Thus, the warming device may raise the temperature of the inlet air flow by at least the same amount as the reduction in temperature that the NEA will experience. This, in turn, may mean that if the inlet air flow is above freezing point then ice will be prevented from forming while the warming device is being used (and if the inlet air flow were below freezing then the ice would have already formed so would be more likely to pass through the inlet duct(s) rather than building up in it/them.

The warming device may comprise an electric heating element.

This may allow the warming device to provide a beneficially powerful warming action. Instead or as well, it may allow the amount of heat delivered by the warming device to be controlled with advantageous ease and/or speed.

Where the warming device comprises an electric heating element, it may be the electric heating element which is provided at the positions discussed above and/or extends around the locations discussed above.

The warming device may comprise a conduit configured to receive a warming fluid from which heat can pass to the inlet passage or into the inlet air flow.

This may allow the warming device to utilize “waste heat”, for instance from an engine coolant system, in warming the inlet passage or inlet air flow. This, in turn, may reduce the power consumption of the warming device (and thus of the inerting system as a whole).

While it may be beneficial to utilize waste heat in this way, in some embodiments the inerting system (or another system) may heat a warming fluid for the sole purpose of warming the inlet passage or inlet air flow.

For the avoidance of doubt the term “warming fluid” is intended to cover either liquids or gases (or a combination of both).

The inerting system may be configured to direct OEA produced by the vortex tube into the conduit as the warming fluid.

Being produced by the vortex tube, the OEA may be particularly suitable as a source of “waste heat” since it may not require transportation from outside the inerting system (whereupon some of the available heat may be lost). Instead or as well, it may be beneficial to remove heat from the OEA since the heat of OEA may otherwise overheat nearby components such as seals or electrical insulation.

The inerting system may further comprise a controller operably connected to the warming device, the controller being configured to selectively activate the warming device so as to selectively warm the at least part of the inlet passage or at least part of the inlet air flow.

Selectively warming the inlet passage or inlet air flow may allow the inerting system to be more energy efficient by only warming the inlet passage or inlet air flow when this is deemed necessary.

Where the warming device comprises an electrical heating element, the controller may deactivate it by cutting power to it. Where the warming device comprises a conduit configured to receive a warming fluid, the controller may deactivate it by stopping the flow of warming fluid or passing the warming fluid through an alternative conduit which is positioned such that heat cannot move from the warming fluid to the inlet passage or into the inlet air flow.

The controller may be configured to selectively activate the warming device based on a signal from a temperature sensor.

Thus, the inerting system may selectively warm the inlet passage or inlet air flow when a relevant temperature drops low enough that ice build-up may take place.

The temperature sensor may be positioned in the inerting system, for instance in or on the vortex tube (e.g., in or on an inlet or the swirl generator), or in or on a duct configured to transport the inlet air flow, the OEA or the NEA.

The controller may be configured to selectively activate the warming device based on a signal from a flow rate sensor and/or a signal from an oxygen concentration sensor.

Thus, the inerting system may selectively warm the inlet passage or inlet air flow when ice may have built up to a point at which the performance of the inerting system (e.g., the throughput of air or the extent to which oxygen is separated into the OEA) is negatively effected.

The flow rate sensor, where present, may be positioned in the inerting system, for instance in or on a duct configured to transport the OEA or the NEA, or in or on a duct configured to transport the input air flow to the vortex tube. The oxygen concentration sensor, where present, may be positioned in the inerting system, for instance in or on a duct configured to transport the OEA or the NEA.

Where the controller is configured to activate and deactivate the warming device based on a signal from a flow rate sensor and a signal from an oxygen concentration sensor, the two sensors may be positioned in the same flow path (e.g., of the OEA or the NEA) or may be positioned in different flow paths.

The controller may be configured to selectively activate the warming device based on a signal from a timer.

Thus, the inerting system may selectively warm the inlet passage or inlet air flow when sufficient time has elapsed for there to be the potential for ice to have built up.

The timer may be part of the inerting system, for instance it may be integral to the controller. In other embodiments the timer may be part of a different system and the signal from the timer may cause that system to prompt the controller.

The inerting system may be configured for substantially constant operation of the warming device while the inerting system is in use.

This may minimize the risk of ice ever forming in the inlet passage, and thus the risk of the performance of the inerting system ever being affected by the buildup of ice.

In some embodiments the inerting system may comprise a controller configured to selectively activate the warming device so as to selectively warm the inlet passage or inlet air flow, but nonetheless be configured for substantially constant operation of the warming device while the inerting system is in use. For example, the controller may be configured to deactivate the warming device as part of an emergency shutdown (for instance if an aircraft comprising the inerting system aircraft suffers a partial power loss and enters a power-saving mode in which all available power is to be conserved for flight systems).

The inerting system may be an aircraft enclosure inerting system.

One or more of the advantages discussed above may be of particular benefit in the aviation sector, where weight saving, space saving and service intervals are key considerations, and where an uninterrupted supply of NEA is of particular importance.

According to a second aspect of the present invention there is provided an aircraft comprising an aircraft enclosure inerting system according to the first aspect of the invention.

Such an aircraft may benefit from one or more of the advantages discussed above, for instance in terms of reliability or weight and space saving.

According to a third aspect of the present invention there is provided a method of supplying nitrogen enriched air (NEA) to an enclosure, the method comprising:
providing an inlet air flow to a vortex tube;
centrifugally separating the inlet air flow into the NEA and oxygen enriched air (OEA) in a vortex chamber of the vortex tube; and
supplying the NEA from the vortex tube to the enclosure,
wherein the method comprises warming at least part of an inlet passage through which the inlet air flow enters the vortex chamber, or warming at least part of the inlet air flow before the inlet air flow enters the vortex chamber.

For the avoidance of doubt, warming at least part of the inlet passage may have the effect of warming at least part of the inlet air flow. Equally, warming at least part of the inlet air flow may have the effect of warming at least part of the inlet passage.

Warming at least part of the inlet passage or inlet air flow may make it less likely for moisture in the inlet air flow to freeze on/in an inlet passage and build up to form an obstruction, and/or may melt accumulated ice so as to clear the accumulated ice from the inlet passage. Also, generally speaking, the warmer the inlet air flow is, the warmer the NEA is and thus the less cooling effect the NEA has on the vortex tube, so the less likely it is for an inlet passage to reach freezing point. With less potential for obstruction from ice, the method may be performed with improved reliability and/or with fewer breaks for maintenance. Further, less potential for obstruction from ice may allow the method to be performed using apparatus that has smaller, lighter and/or cheaper air drying equipment, or may even allow the method to be performed without any requirement for such equipment.

Instead or as well, dealing with ice accumulation by heating the inlet passage or inlet air flow may allow the NEA to continue to be provided even while ice is being cleared, in contrast to other ways of clearing ice (such as shutting down the vortex tube until the ice melts, or passing de-icing liquid down the vortex tube).

Warming at least part of the inlet passage may mean less power is required to clear ice and/or prevent ice forming in the inlet passage, since it may be more economical to warm only the inlet passage than continually warming part of an air flow. In contrast, warming at least part of the inlet air flow upstream of the inlet passage may take more power as some may be wasted heating parts of the inlet air flow which do not ultimately contact the inlet passage as it flows through it. Having said this, warming at least part of the inlet air flow may allow the vortex tube (and thus the inerting system as a whole) to be advantageously simple, since inlet passages of vortex tubes are often small and inaccessible components which do not lend themselves to being heated, which may allow the method to be performed at reduced cost.

Where the method comprises warming at least part of the inlet passage, it may comprise warming the at least part of the inlet passage directly, or indirectly via one or more intermediate components.

The method may be performed as a continuous process (i.e., with the inlet passage or inlet air flow being warmed while previously-warmed inlet air is being separated and already-separated NEA is being supplied to the enclosure).

Where the method comprises warming at least part of the inlet air flow, the method may comprise warming a stored volume of air before supplying it, as the inlet air flow, to the vortex tube. As an alternative, the method may comprise warming the inlet air flow as it flows towards the vortex tube.

The method may comprise warming substantially all of the inlet passage, or substantially all of the inlet air flow before it enters the vortex chamber.

This may magnify the extent to which one or more of the above advantages are provided.

The method may comprise warming at least part of the inlet air flow before it enters an inlet passage through which the inlet air flow enters the vortex chamber.

This may be beneficial in that more space may be available upstream of the inlet passage. This may allow more thorough and/or more efficient warming of the inlet air flow than would be the case in tighter spaces.

The at least part of the inlet passage or at least part of the inlet air flow may be warmed by at least 20 degrees Celsius, for instance at least 30 degrees, at least 40 degrees, at least 50 degrees or at least 60 degrees, before it enters the vortex chamber.

This may make it more likely for the inlet passage or inlet air flow to be heated sufficiently for ice to be melted or prevented from forming.

Raising the temperature of substantially all the inlet air flow by at least 50 degrees Celsius may be of particular benefit since methods using vortex tubes of conventional design typically produce NEA that is around 50 degrees colder than the inlet air flow. Thus, the temperature of the inlet air flow may be raised by at least the same amount as the reduction in temperature that the NEA will experience. This, in turn, may mean that if the inlet air flow is above freezing point then ice will be prevented from forming while the warming device is being used (and if the inlet air flow were below freezing then the ice would have already formed so would be more likely to pass through the inlet duct(s) rather than building up in it/them).

The method may comprise selectively warming the at least part of the inlet passage or at least part of the inlet air flow at some times, and not warming the at least part of the inlet passage or at least part of the inlet air flow at other times.

Selectively warming or not warming the inlet passage or inlet air flow may allow the method to be more energy efficient by only expending energy warming the inlet passage or inlet air flow when this is deemed necessary.

The method may comprise stopping warming the inlet air flow or inlet passage by cutting power to an electrical heating element. Instead or as well, the method may comprise stopping warming the inlet air flow or inlet passage by stopping the flow of a warming fluid through a conduit from which heat would otherwise pass from the warming fluid to the inlet air flow or inlet passage, or passing the warming fluid through an alternative conduit which is positioned such that heat cannot move from the warming fluid to the inlet passage or into the inlet air flow.

The at least part of the inlet passage or at least part of the inlet air flow may be warmed if a temperature reading of a temperature sensor drops below a predetermined value.

Thus, the inlet passage or inlet air flow may be warmed when a relevant temperature drops low enough that ice build-up may take place.

The temperature sensor may be positioned in the inerting system, for instance in or on the vortex tube (e.g., in or on an inlet or a swirl generator), in or on a duct configured to transport the inlet air flow, the OEA or the NEA.

The at least part of the inlet passage or at least part of the inlet air flow may be warmed if a signal from a flow rate sensor and/or a signal from an oxygen concentration sensor indicates a potential obstruction in an inlet passage through which the inlet air flow can enter the vortex chamber.

Thus, the inlet passage or inlet air flow may be warmed when ice may have built up to a point at which the performance of the inerting system (e.g., the throughput of air or the extent to which oxygen is separated into the OEA) is negatively effected.

The flow rate sensor, where present, may be positioned in the inerting system, for instance in or on a duct configured to transport the OEA or the NEA, or in or on a duct configured to transport the input air flow to the vortex tube. The oxygen concentration sensor, where present, may be positioned in the inerting system, for instance in or on a duct configured to transport the OEA or the NEA.

Where the inlet passage or inlet air flow is warmed if a signal from a flow rate sensor and a signal from an oxygen concentration sensor indicates a potential obstruction, the two sensors may be positioned in the same flow path (e.g., of the OEA or the NEA) or may be positioned in different flow paths.

The method may comprise warming the at least part of the inlet passage or at least part of the inlet air flow substantially throughout centrifugal separation of the air.

This may minimize the risk of ice ever forming in the inlet passage, and thus the risk of the performance of the inerting system ever being affected by the buildup of ice.

In some embodiments the inlet passage or inlet air flow may be warmed substantially throughout centrifugal separation of the air, but the method may nonetheless comprise selectively warming the inlet air flow at some times and not warming the inlet air flow at other times. For example, the inlet air flow or inlet passage might not be warmed during an emergency shutdown (for instance if an aircraft comprising the inerting system aircraft suffers a partial power loss and enters a power-saving mode in which all available power is to be conserved for flight systems).

The method may use the apparatus of the first or second aspect of the invention.

It will of course be appreciated that features described in relation to one aspect of the present invention may be incorporated into other aspects of the present invention.

### BRIEF DESCRIPTION OF THE DRAWINGS

Embodiments of the present invention will now be described by way of example only with reference to the accompanying schematic drawings of which:

FIG. 1 shows a plan view of an aircraft according to a first embodiment of the invention;

FIG. 2 shows a simplified cross-sectional side view of a vortex tube of an enclosure inerting system of the aircraft of FIG. 1;

FIG. 3 shows a simplified cross-sectional end view of the vortex tube of FIG. 2;

FIG. 4 shows a schematic of an inerting system of the aircraft of FIG. 1, which includes the vortex tube of FIGS. 2 and 3;

FIG. 5 shows a flow chart of a method according to the first embodiment of the invention;

FIG. 6 shows a simplified cross-sectional side view of a vortex tube of a second embodiment of the invention;

FIG. 7 shows a simplified cross-sectional end view of a vortex tube according to a third embodiment of the invention;

FIG. 8 shows a simplified cross-sectional end view of a vortex tube according to a fourth embodiment of the invention; and

FIG. 9 shows a schematic of an inerting system according to a fifth embodiment of the invention.

### DETAILED DESCRIPTION OF THE PREFERRED EMBODIMENTS

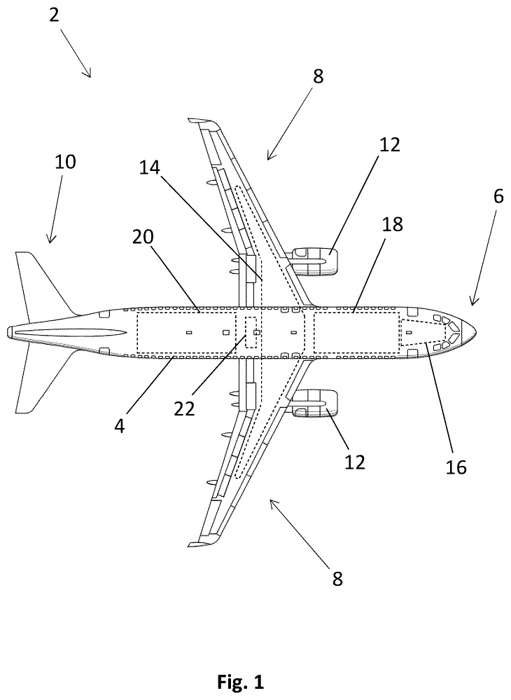

FIG. 1 shows an aircraft 2 according to a first embodiment of the invention. It has a fuselage 4 with a nose 6, two wings 8 and a tail 10. Each wing 8 extends from the fuselage 4 in a spanwise direction and supports an engine 12 part way along its spanwise length. An enclosure in the form of a fuel tank 14 extends inside the wings 8 and through the fuselage 4 therebetween. Behind the nose 6, roughly beneath the cockpit, is another enclosure 16 which, in this case, contains some of the power electronics of the aircraft. Also positioned within the fuselage is a cargo bay made up of a fore enclosure 18 and an aft enclosure 20. The aircraft 2 also has an enclosure inerting system 22 which is arranged to provide NEA to each of the enclosures 14, 16, 18, 20 as discussed below.

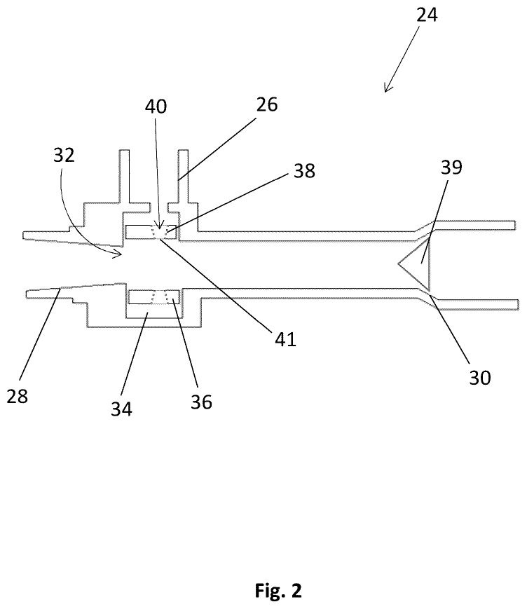

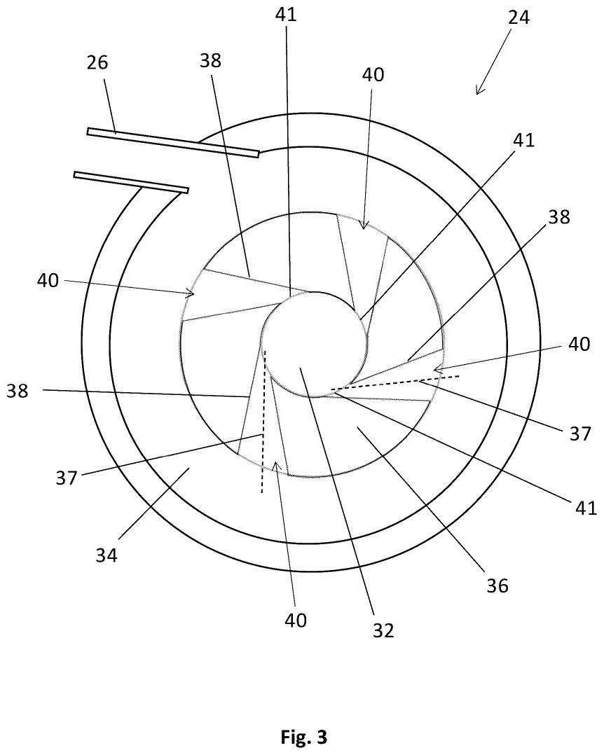

The inerting system 22 receives an inlet air flow from a ram air channel (not visible), then pressurizes the inlet air flow using a compressor (not visible) before cooling it using a heat exchanger (not visible) which brings the temperature of the compressed air down to a manageable level. The inerting system 22 separates the inlet air flow into NEA, which is supplied to the enclosures 14, 16, 18, 20 as needed, and OEA which is exhausted overboard. This separation of air takes place centrifugally, in a vortex tube. The vortex tube is shown schematically in FIGS. 2 and 3, which will now be referred to in combination with FIG. 1.

The vortex tube 24 has an inlet 26, an NEA outlet 28 and an OEA outlet 30. The vortex tube 24 defines a vortex chamber 32, which is circumferentially surrounded by a plenum chamber 34 fed from the inlet 26. Positioned concentrically between the plenum chamber 34 and the vortex chamber 32, and separating the plenum chamber 34 from the vortex chamber 32 from each other, is a swirl generator 36. The swirl generator 36 of this embodiment has a set of four inlet passages 38 extending therethrough along respective longitudinal axes 37 (two of which are shown in FIG. 3). In other embodiments, however, a swirl generator may have any suitable number of inlet passages such as one, two, three, five or ten.

The inlet passages 38 are positioned at intervals of 90 degrees in an annular array which extends circumferentially around the vortex chamber 32. The inlet passages 38 provide respective flow paths 40 through which air can flow from the plenum chamber 34 into the vortex chamber 32. In this embodiment the inlet passages 38 take the form of tangential inlets which impart swirl into air flow entering the vortex chamber 32. Each inlet passage 38 intersects the vortex chamber 32 at a chamber inlet aperture 41.

The NEA outlet 28 takes the form of a gradually widening aperture extending away from the vortex chamber 32 in one axial direction. The OEA outlet 30 takes the form of an annular passageway positioned circumferentially around a conical projection 39 and extending away from the vortex chamber 32 in the opposite axial direction to the NEA outlet.

In use, the inlet air flow enters the plenum chamber 34 through the inlet 26. The inlet air flow then enters the vortex chamber 32 tangentially through the inlet passages 38 of the swirl generator 36. The inlet passages 38 narrow towards the vortex chamber 32, which accelerates the air passing through them, and introduce the air into the vortex chamber 32 tangentially so as to impart swirl as mentioned above. As the air swirls within the vortex chamber 32, it separates into an outer vortex travelling helically in one direction (to the right from the perspective of FIG. 2) and an inner vortex travelling in the other direction (to the left from the perspective of FIG. 2), with both vortices rotating in the same direction.

The rotation of the air in the two vortices has the effect of throwing the heavier gasses outwards into the outer vortex, with lighter gasses remaining in (or being displaced into) the inner vortex. With oxygen being heavier than nitrogen, the oxygen tends to be thrown out into the outer vortex while the nitrogen tends to remain in the inner vortex. Accordingly, the inner vortex is made up of NEA and the outer vortex is made up of OEA. The NEA forming the inner vortex exits the vortex chamber 32 through the NEA outlet 28, whereupon, in this embodiment, it is fed to a storage tank (not shown) of the inerting system 22 for onward distribution to the enclosures 14, 16, 18, 20 as needed. The OEA forming the outer vortex exits the vortex chamber 32 through the OEA outlet 30, whereupon it is directed towards an exhaust port (not shown) of the inerting system 22 (and of the aircraft as a whole).

Heavier gasses being thrown out from the inner vortex and into the outer vortex also has the effect of expanding the air in the inner vortex and compressing the air in the outer vortex. This has the effect of cooling the NEA in the inner vortex and heating the OEA in the outer vortex.

In this particular embodiment, the position of the conical projection 39 is movable axially so as to vary the cross sectional area of the OEA outlet 30. Changing the cross sectional area of the OEA outlet 30 has the effect of altering the proportion of air which exits through that outlet 30 rather than the NEA outlet 28, which affects the relative sizes of the inner and outer vortices. This, in turn, affects the degree of air separation performed by the vortex tube 24 and the flow rates of OEA and NEA produced. The conical projection 39 therefore functions as a calibration valve which can be adjusted during manufacture of the aircraft (or during routine servicing).

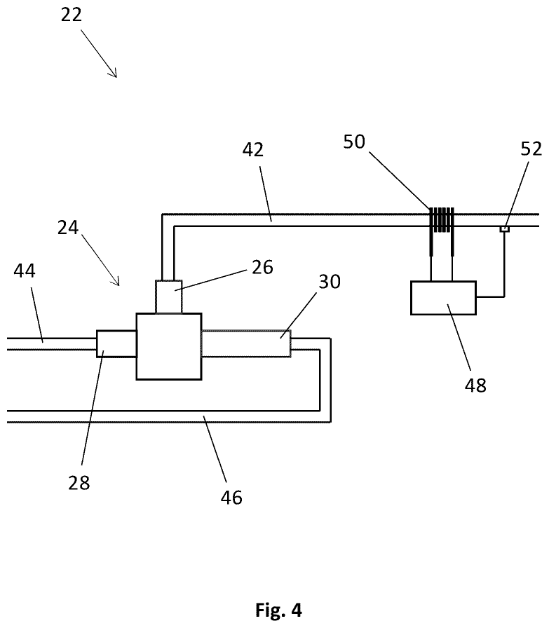

The complete inerting system 22 of the present embodiment is shown in FIG. 4, which will now be referred to in combination with FIGS. 1 to 3. As well as the vortex tube 24, the inerting system has an inlet duct 42, an NEA duct 44 and an OEA duct 46. The inlet duct 42 is connected to the inlet 26 of the vortex tube 24 and configured to supply the inlet air flow to the inlet 26 (in this case from the ram air channel, as discussed above). The NEA duct 44 is connected to the NEA outlet 28 of the vortex tube 24 and is configured to transport the flow of NEA from the outlet 28 towards the enclosures 14, 16, 18, 20. The OEA duct 46 is connected to the OEA outlet 30 of the vortex tube 24 and is configured to transport the flow of OEA from the outlet 30 to the exhaust port (not visible) from which it can be ejected overboard.

The inerting system 22 also has a controller 48 operably connected to a warming device 50 positioned upstream of the vortex tube 24. The controller 48 is also coupled to a temperature sensor 52 positioned on the inlet duct 42 upstream of the warming device 50. The controller 48 is further configured to receive signals corresponding to temperature readings of the temperature sensor 52.

The warming device 50 takes the form of an electric heating element with a coil that encircles the inlet duct 42. It is configured to warm the inlet air flow as it passes along the inlet duct 42, upstream of the vortex tube 24 (thus before the inlet air flow reaches any of the chamber inlet apertures 41). The warmed inlet air flow gives up some heat to the swirl generator 36 as it flows through the inlet passages 38, meaning that the inlet passages 38 are warmed indirectly by the warming device 50. The heating element 50 is under control of the controller 48, which can selectively activate it, when desired, to raise the temperature of the inlet air flow passing through the heating element 50 by around 60 degrees Celsius.

In the present embodiment the controller 48 is configured to activate or deactivate the heating element 50 based on the signals received from the temperature sensor 52. More particularly, the controller 48 is configured to send power to the heating element 50 (i.e., activate it) whenever the signal from the temperature sensor 52 equates to a reading of 50 degrees or less, and to not send power to the heating element 50 (so as to deactivate it) whenever the signal from the temperature sensor 52 equates to a reading of more than 50 degrees.

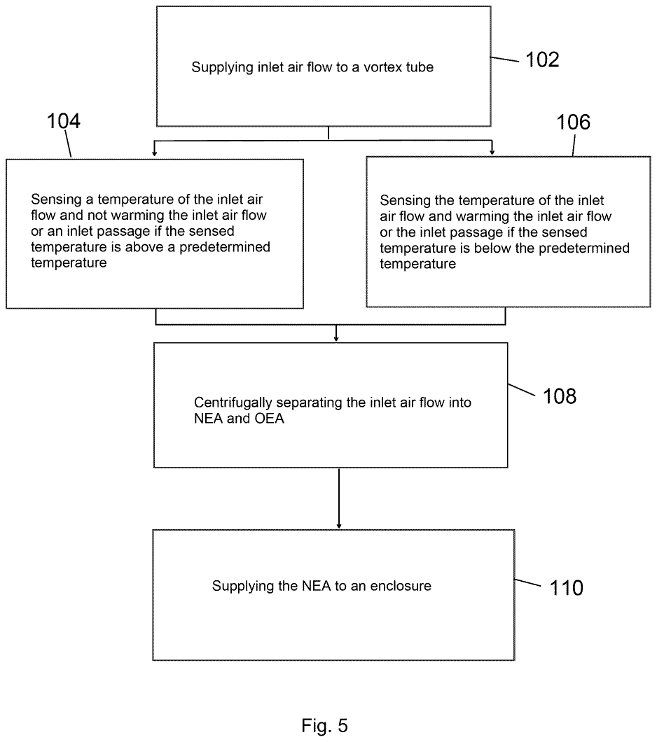

A method of using the inerting system 22 (and indeed the aircraft 2 as a whole) will now be described with reference to FIG. 5, in combination with FIGS. 1 to 4.

To begin use of the inerting system 22, the inlet air flow is supplied 102 to the vortex tube 24 through the inlet duct 42 from the ram air channel (not visible). The temperature sensor 52 reads the temperature of the inlet air flow as it passes through the inlet duct 42, and sends corresponding signals to the controller 48. If the controller 48 determines from these signals that the inlet air flow has a temperature of more than 50 degrees then it does not supply power to the heating element 50 and thus the inerting system 22 does not warm 104 the inlet air flow. If on the other hand the controller 48 determines that the inlet air flow has a temperature of 50 degrees or less then it supplies power to the heating element 50, activating it and warming 106 the inlet air flow by 60 degrees. As use of the inerting system 22 continues, the controller selectively activates the heating element 50 whenever the inlet air flow drops to 50 degrees or below, and deactivates the heating element 50 whenever the inlet air flow exceeds 50 degrees.

After passing the heating element 50 the inlet air flow, warmed or not as appropriate, passes through the remainder of the inlet duct 42 and into the inlet 26 of the vortex tube. From there, the air passes into the plenum chamber 34, through the inlet passages 38 and into the vortex chamber 32 through the chamber inlet apertures 41.

In the vortex chamber 32, the inlet air flow is centrifugally separated 108 into NEA and OEA as described above. The NEA is then supplied 110 to one or more of the enclosures 14, 16, 18, 20 as needed, while the OEA is ejected overboard.

For the avoidance of doubt, FIG. 5 shows each of the above stages happening in sequence, as they would be experienced by a parcel of air travelling through the inerting system 22. However, each stage also takes place concurrently, with some inlet air being warmed while some already-warmed air is being separated and some already-separated NEA is being supplied.

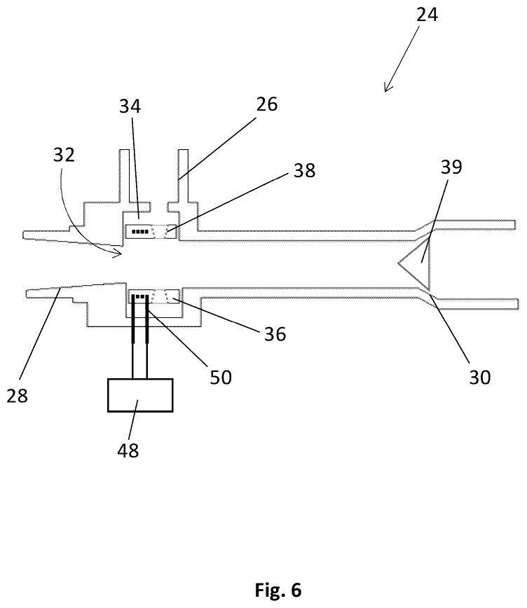

A vortex tube of an aircraft according to a second embodiment of the invention is shown in FIG. 6, which will now be referred to in combination with FIGS. 1 to 5. The second embodiment is similar to the first embodiment, therefore only the differences will be described. Corresponding reference numerals denote corresponding features.

In the second embodiment the warming device 50 takes the form of a coiled electrical heating element as is the case in the first embodiment. In the second embodiment, however, the heating element 50 is part of the vortex tube 24. More particularly, the heating element 50 is embedded inside the swirl generator 36, with its coil running circumferentially around the vortex chamber 32. The warming device 50 of this embodiment therefore warms the swirl generator 36, and thus the inlet passages 38, directly. The warming device 50 also warms the inlet air flow, however, as it passes through the inlet passages 38. It is noteworthy that with the swirl generator 36 dividing the vortex chamber 32 and plenum chamber 34, it forms a wall of the vortex chamber 32 and also a wall of the plenum chamber 34. Thus, in this embodiment the warming device 50 may be considered to be provided in a wall defining the vortex chamber 32, and may equally be considered to be provided in a wall defining the plenum chamber 34.

With the vortex tube 24 comprising the warming device 50, in this embodiment the inlet air flow remains unheated as it passes along the inlet duct 42 and into the inlet 26 of the vortex tube 24. Only when it enters the plenum chamber 34 does the inlet air flow begin to be warmed.

The second embodiment also differs from the first in that the inerting system 22 does not have a temperature sensor. In the present embodiment the inerting system 22 is configured for substantially constant operation of the warming device 50 while the inerting system 22 is in use. The controller 48 sends power to the heating element 50 whenever centrifugal separation of air is taking place, with the exception that it will cut power to the heating element 50 if it detects a fault in the heating element 50.

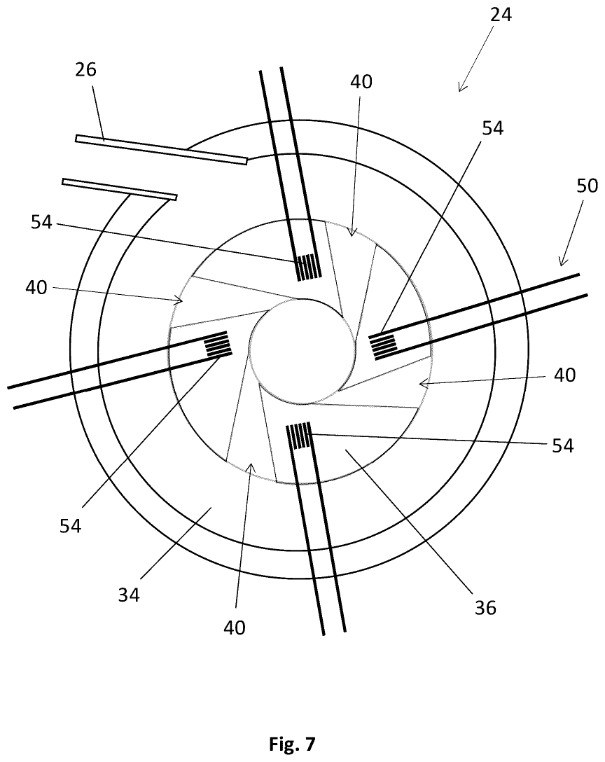

A vortex tube of an aircraft according to a third embodiment of the invention is shown in FIG. 7, which will now be referred to in combination with FIGS. 1 to 6. The third embodiment is also similar to the first embodiment, therefore again only the differences will be described.

In the present embodiment the heating element 50 comprises four discrete coils 54, each positioned between an adjacent pair of inlet passages 38. In the present case the four coils 54 are connected in parallel, so may each be thought of as discrete sub-units. Nonetheless, with the four coils 54 being spaced about the vortex chamber 32 the heating element 50 as a whole may still be considered to extend circumferentially around the vortex chamber 32.

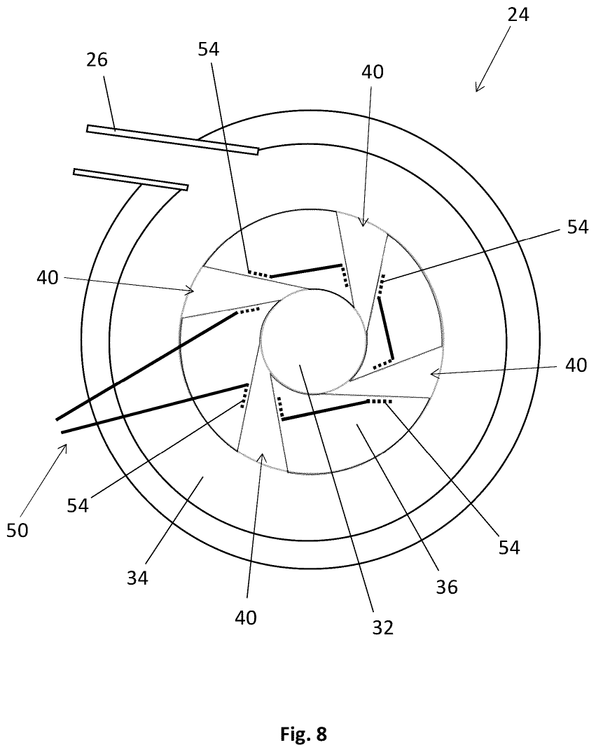

A vortex tube of an aircraft according to a fourth embodiment of the invention is shown in FIG. 8, which will now be referred to in combination with FIGS. 1 to 7. The fourth embodiment is similar to the third embodiment, therefore only the differences will be described.

In the fourth embodiment, each discrete coil 54 of the heating element 50 extends circumferentially around a respective inlet passage 38 (with respect to the longitudinal axis 37 of that inlet passage). Thus, the heating effect of the heating element 50 is focused in particular on the inlet passages 38 (and on the inlet air flow passing therethrough).

It is noteworthy that even though each inlet passage 38 has an associated coil 54 of the heating element 50, it is still true to say that the warming device extends between adjacent inlet passages since each coil 54 runs between its associated inlet passage 38 and an adjacent one, then circles around and runs between its associated inlet passage 38 and the other adjacent one, and so on.

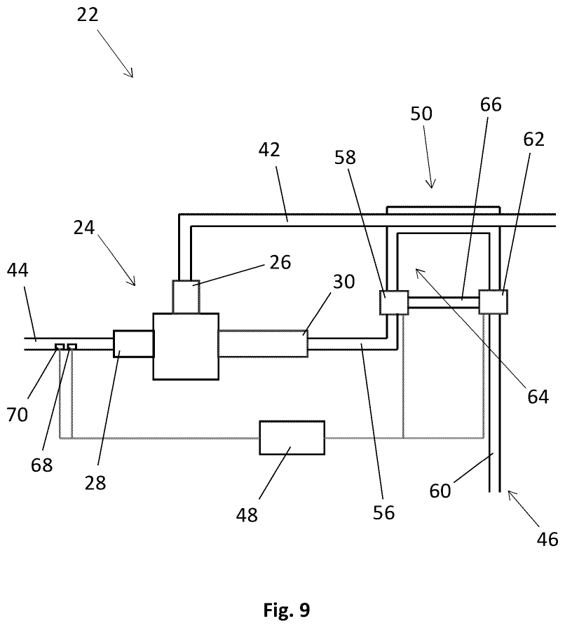

An inerting system of an aircraft according to a fifth embodiment of the invention is shown in FIG. 9, which will now be referred to in combination with FIGS. 1 to 8. The fifth embodiment is similar to the first embodiment, therefore only the differences will be described.

In the present embodiment the OEA duct 46 is made up of four separate parts and two valves. An upstream part 56 connects the OEA outlet 30 to a first valve 58. A downstream part 60 extends from a second valve 62 and is configured for connection to the exhaust port (not shown) through which the OEA can be exhausted overboard. Between the first and second valves 58, 62 are a conduit 64 and a bypass path 66. The first valve 58 is operable by the controller 48 to connect the upstream part 56 to either the conduit 64 or the bypass path 66. The second valve 62 is operable by the controller 48 to connect either the conduit 64 or the bypass path 66 to the downstream part 60.

The warming device 50 of this embodiment takes the form of a heat exchanger in which the OEA produced by the vortex tube 24 functions as the warming fluid. A section of conduit 64 surrounds a section of the inlet duct 42, with those sections forming a double-pipe heat exchanger in which heat from the OEA can pass into the inlet air flow so as to warm it.

In the present embodiment the controller 48 can activate or deactivate the warming device by controlling the valves 58, 62. By operating the valves 58, 63 to connect the upstream part 56 and downstream part 60 to the conduit 64, the OEA produced by the vortex tube 24 is routed through the conduit 64 and heat passes from the OEA into the inlet air flow. By operating the valves 58, 63 to connect the upstream part 56 and downstream part 60 to the bypass path 66, the OEA produced by the vortex tube 24 bypasses the conduit 64 and no heat passes from the OEA into the inlet air flow.

In the fifth embodiment the controller 48 is connected to a flow rate sensor 68 and an oxygen concentration sensor 70, rather than a temperature sensor. The flow rate sensor 68 and oxygen concentration sensor 70 are both positioned in the NEA duct 44, and send to the controller 48 respective signals indicative of flow rate and oxygen concentrations readings. The controller 48 monitors these signals and if they indicate a potential obstruction in an inlet passage 38 (for instance if the signals indicate that the flow rate of NEA has gone down and its oxygen concentration has gone up) then the controller activates the heat exchanger 50 so as to warm the inlet air flow. Thus, if the obstruction is caused by ice build-up, the ice can be cleared. If the signals from the sensors 68, 70 do not indicate a potential obstruction (or cease to indicate a potential obstruction) then the controller 48 deactivates the heat exchanger 50 and the inlet air flow enters the vortex chamber 32 having not been warmed.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents.

It will also be appreciated by the reader that integers or features of the invention that are described as preferable, advantageous, convenient or the like are optional and do not limit the scope of the independent claims. Moreover, it is to be understood that such optional integers or features, while of possible benefit in some embodiments of the invention, may not be desirable, and may therefore be absent, in other embodiments.

The systems and devices described herein may include a controller, such as controller 48, control unit, control device, controlling means, system control, processor, computing unit or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. An inerting system configured to separate an inlet air flow into nitrogen enriched air (NEA) and oxygen enriched air (OEA), the inerting system having a vortex tube comprising:
a vortex chamber configured to centrifugally separate the inlet air flow into the NEA and the OEA; and
a swirl generator having an inlet passage configured to allow the inlet air flow to enter the vortex chamber, the inlet passage and vortex chamber intersecting at a chamber inlet aperture, and
a warming device configured to warm at least part of the inlet passage, or at least part of the inlet air flow upstream of the chamber inlet aperture.

2. The inerting system according to claim 1 wherein the warming device is provided in or on the vortex tube.

3. The inerting system according to claim 2 wherein:
the vortex tube comprises an inlet duct in communication with a plenum chamber, the inlet passage of the swirl generator providing a flow path from the plenum chamber into the vortex chamber; and
the warming device is provided at a wall defining the plenum chamber.

4. The inerting system according to claim 2 wherein the warming device extends circumferentially around the vortex chamber.

5. The inerting system according to claim 2 wherein the warming device is provided in or on the swirl generator.

6. The inerting system according to claim 5 wherein:
the swirl generator has a plurality of inlet passages configured to allow the inlet air flow to enter the vortex chamber, each inlet passage intersecting the vortex chamber at a respective chamber inlet aperture; and
the warming device extends in or on the swirl generator between adjacent inlet passages.

7. The inerting system according to claim 2 wherein the inlet passage defines a longitudinal axis, and the warming device extends circumferentially around the inlet passage.

8. The inerting system according to claim 1 wherein the warming device is configured to warm at least part of the inlet air flow and is positioned upstream of the vortex tube.

9. The inerting system according to claim 1 wherein the warming device is configured to raise a temperature of said at least part of the inlet passage or at least part of the inlet air flow by at least 50 degrees Celsius.

10. The inerting system according to claim 1 wherein the warming device comprises an electric heating element.

11. The inerting system according to claim 1 wherein the warming device comprises a conduit configured to receive a warming fluid and configured to allow heat to pass from the conduit into the inlet air flow.

12. The inerting system according to claim 11 wherein the inerting system is configured to direct OEA produced by the vortex tube into the conduit as the warming fluid.

13. The inerting system according to claim 1 further comprising a controller operably connected to the warming device, the controller being configured to selectively activate the warming device so as to selectively warm said at least part of the inlet passage or at least part of the inlet air flow.

14. The inerting system according to claim 13 wherein the controller is configured to selectively activate the warming device based on a signal from a temperature sensor.

15. The inerting system according to claim 13 wherein the controller is configured to selectively activate the warming device based on a signal from at least one of a flow rate sensor or a signal from an oxygen concentration sensor.

16. The inerting system according to claim 1 wherein the inerting system is configured to provide substantially constant operation of the warming device while the inerting system is in use.

17. The inerting system according to claim 1 wherein the inerting system is an aircraft enclosure inerting system.

18. An aircraft comprising an aircraft enclosure inerting system according to claim 17.

19. A method of supplying nitrogen enriched air (NEA) to an enclosure, the method comprising:
providing an inlet air flow to a vortex tube;
centrifugally separating the inlet air flow into the NEA and oxygen enriched air (OEA) in a vortex chamber of the vortex tube; and
supplying the NEA from the vortex tube to the enclosure,
wherein the method comprises warming at least part of an inlet passage through which the inlet air flow enters the vortex chamber, or warming at least part of the inlet air flow before the inlet air flow enters the vortex chamber.

20. The method according to claim 19 further comprising selectively passage or at least part of the inlet air flow is warmed if a signal from at least one of a flow warming said at least part of the inlet passage or at least part of the inlet air flow at some times, and not warming said at least part of the inlet passage or at least part of the inlet air flow at other times.
